(19) United States
(12) Patent Application Publication
(10) Pub. No.: US 2013/0117326 A1
(43) Pub. Date: May 9, 2013

(54) EXTERNAL SERIALIZATION AND DESERIALIZATION

(71) Applicants: Bart De Smet, Bellevue, WA (US); Henricus Johannes Maria Meijer, Mercer Island, WA (US)

(72) Inventors: Bart De Smet, Bellevue, WA (US); Henricus Johannes Maria Meijer, Mercer Island, WA (US)

(73) Assignee: MICROSOFT CORPORATION, Redmond, WA (US)

(21) Appl. No.: 13/291,380

(22) Filed: Nov. 8, 2011

(51) Int. Cl. G06F 17/30

(52) U.S. Cl. 707/798; 707/E17.055

(57) ABSTRACT

An object graph can be transformed from a first form to a second form based on metadata discovered about objects of the object graph external to a corresponding object model. In one instance, transformation can correspond to serialization and deserialization.

### BACKGROUND

Serialization and deserialization facilitate data storage and transmission. Serialization is a process of converting an object or group of objects (a.k.a., object graph) into a format (e.g., binary, XML (Extensible Markup Language), JSON (JavaScript Object Notation) . . . ) conducive to storage on a computer-readable medium or transmission across a communication network. Deserialization is a process that reconstructs a serialized object or group of objects in the same or semantically equivalent format. Serialization is also called deflating or marshalling, and, in the opposite direction, deserialization is also referred to as inflating or unmarshalling.

Programming languages often provide mechanisms to support object serialization and deserialization. For example, an interface can be implemented or custom attributes can be specified, among other things. Thus, objects can be written such that serialization and deserialization can be provided. In other words, objects are defined during design time with serialization and deserialization in mind

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to external serialization and deserialization, or more generally external transformation. Objects designed without support for serialization and deserialization can be serialized and deserialized externally, for instance with respect to a corresponding object model. In other words, serialization and deserialization of objects of an object model are accomplished without altering or otherwise impacting original corresponding types. Serialization and deserialization functions can be acquired from a developer and/or automatically discovered or inferred. An object graph can be traversed and appropriate serialization functions selected and executed, for instance recursively, based on object metadata. Subsequently, deserialization functions can be located based on serialized object metadata and applied to deserialize serialized data. In accordance with one particular aspect, serialization can be configurable to enable various levels of detail to be serialized and subsequently deserialized.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of an external serialization/deserialization system.

FIG. 2 is a block diagram of a representative serialization component.

FIG. 3 illustrates utilization of context for cycle detection.

FIG. 4 is a block diagram a representative deserialization component.

FIG. 5 illustrates an exemplary serialization and deserialization scenario.

FIG. 6 is a flow chart diagram of a method of serialization.

FIG. 7 is a flow chart diagram of method of serialization.

FIG. 8 is a flow chart diagram of method of facilitating serialization and deserialization.

FIG. 9 is a flow chart diagram of a method of deserialization.

FIG. 10 is a schematic block diagram illustrating a suitable operating environment for aspects of the subject disclosure.

### DETAILED DESCRIPTION

Details below are generally directed toward data transformation including, but not limited, to serialization and deserialization. Conventionally, serialization of object graphs assumes a closed-world model where objects have been written such that serialization and deserialization can be provided. This may involve the use of custom attributes or implementation of interfaces, among other things. In other words, a conscious decision is made by a developer to allow an instance of a type, or object, to be serializable, which is not serializable by default. A problem arises if serialization and deserialization is desired with respect to a type that was designed without serialization in mind, or, in other words, there is no support for serialization and deserialization with respect to an object model as conventionally required. To address this problem, an open-world model can be employed that performs external serialization with respect to an object model. Stated differently, serialization of objects of an object model is accomplished without altering or otherwise impacting original corresponding types. For example, metadata can be discovered about an object and utilized to generated and/or select a function to serialize or deserialize the object.

To aid clarity and understanding, aspects of the subject disclosure are described in the context of serialization and deserialization. However, the subject matter is not limited thereto. More generally, aspects relate to transformations between types utilizing a function and inverse function. This means type “A” can be converted to type “B” and back from type “B” to type “A.” More specifically, an integer can be transformed to a string and back from a string to an integer. It is like embedding a first type into a second type and allowing the first type to be recovered. One use case is serialization and deserialization, but there can be others including, among others, conversion between object models for compatibility purposes.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

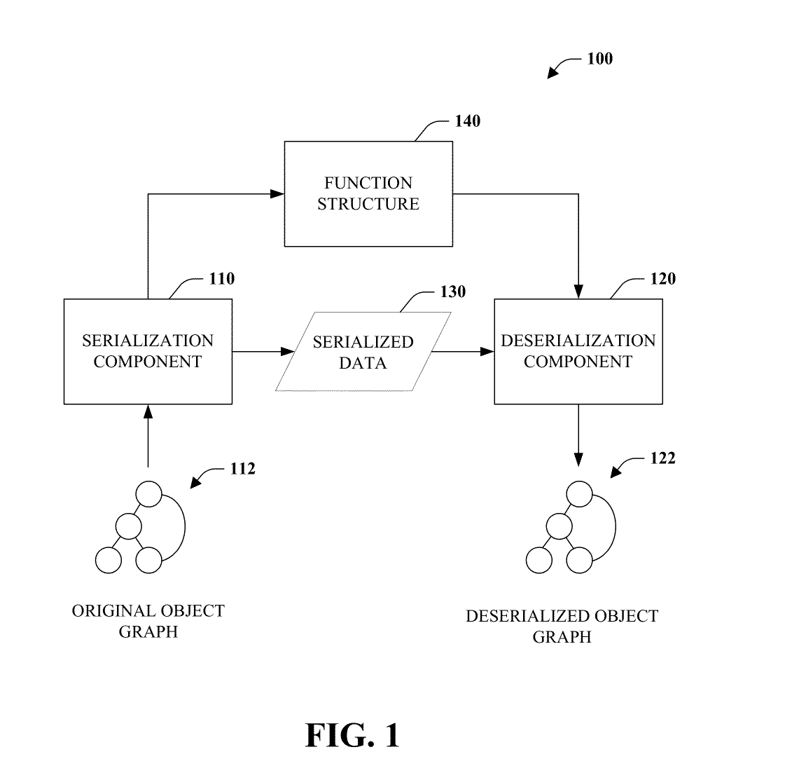

Referring initially to FIG. 1, an external serialization/deserialization system 100 is illustrated. The system 100 includes serialization component 110 configured to serialize objects and deserialization component 120 configured to deserialize objects. More specifically, the serialization component 110 is configured to receive, retrieve, or otherwise obtain or acquire an object graph 112 (a.k.a. original object graph), comprising a number of objects and their relations, and transform the object graph 112 into serialized data 130 with assistance from function structure 140. Subsequently, the deserialization component 120 can receive, retrieve or otherwise obtain or acquire the serialized data 130 and transform it into deserialized object graph 122 with aid from the function structure 140.

In addition to providing conventional serialization functionality, the serialization component 110 is extended to support external serialization of objects, where an object type was designed without serialization in mind In this case, types can be beyond the control of a serializing party, and, as a result, altering a type after the fact to support serialization may not be possible. As will be discussed in further detail below, the serialization component 110 can discover metadata regarding objects (e.g., properties) and generated and/or select serialization functions based at least in part on the metadata. More particularly, the serialization component 110 can generated and/or select serialization functions with respect to function structure 140 and apply the selected functions to convert objects into a serialized form.

The function structure 140 stores functions and inverse functions for use in serialization and deserialization. Although not limited thereto, the function structure can be embodied as a table of rules and related serialization and deserialization functions as provided below in TABLE 1:

TABLE 1

| Rule | Input →Output | Output → Input |
|---|---|---|
| A | Function A | Inverse Function A |
| B | Function B | Inverse Function B |
| . . . | . . . | . . . |

The table is indexed by rules associated with a function and inverse function pair, where function corresponds to serialization and inverse function corresponds to deserialization. Of course, the table could be partial in the sense that it includes a serialization function or a deserialization function rather than both. Rules can be associated with types, for example, and selected on that basis. For example, rule “A” could be associated with type integer and function “A” and could be selected and utilized to transform an object of type integer into an object of type string. The rules, functions, and inverse functions can be supplied manually (e.g., hand-coded), automatically, or semi-automatically as will be described later herein. Furthermore, as described herein the table is mostly used as a runtime construct. However, the table could also be used as a compile time construct to generate serialization and deserialization functions similar to compiler generators (e.g., lex, yacc . . . ) or a hybrid such that a runtime table driven approach is utilized in one direction and a hand-coded approach in another direction, for example.

The deserialization component 120 is configured to support conventional deserialization functionality as well as extended functionality such as when types are defined without serialization and subsequent deserialization in mind More specifically, the deserialization component 120 can be configured to analyze serialized data 130, and based on that analysis, select deserialization functions from the function structure 140. For example, a deserialization function can be selected based on a discovered type of an object and applied to a serialized version of the object to deserialize the object.

The original object graph 112 accepted as input to the serialization component 110 and the deserialized object graph 122 output by the deserialization component 120 can, but need not, be the same. Where full fidelity serialization is desired, the original object graph 112 and the deserialized object graph 122 can be the same or substantially similar. Otherwise, the original object graph 112 and the resulting deserialized object graph 122 can be different by limiting data that is serialized based on what is known to be needed. In other words, the serialization component 110 is configurable to enable serialization at different levels of detail, for example from serialization that preserves substantially all data to serialization that intentionally loses, or drops, at least a portion of data such as that which is not employed by a target deserialization entity. For example, if in one world where serialization is being performed a substantial amount of type information is utilized (e.g., .Net) and in another world where deserialization is performed no type information is utilized (e.g., JavaScript), at least a subset of type information can be omitted during serialization. In this and other manners, the serialization component 110 can implement functionality analogous to lossy compression.

Among other things, the original object graph 112 can represent a code expression that can be communicated and executed in a different address space, for example. In this scenario, the code expression can be serialized, communicated to the different address space, deserialized, and subsequently executed.

In one embodiment, the code expression can correspond to a query expression that describes data to be retrieved from one or more sources as well as a shape and organization of returned data in a declarative query-syntax similar to SQL (Structured Query Language). For example, the query expression can form expression can form part of a language-integrated query (LINQ) system that provides a convenient and declarative shorthand query syntax to facilitate specification of queries across arbitrary data sources within a programming language (e.g., C#®, Visual Basic®. . . ) by mapping query operators (e.g., select, where, join, min, max . . . ) to lower level-level primitives, such as methods, that implement the operators the names represent. In one instance, a query expression can be transmitted to a database server process to exploit runtime services inside the database to execute a query rather than going through an intermediate syntax such as T-SQL, requiring redundant compilation and checking on different levels. In another instance, the query expression can be split up and portions distributed for execution across many systems to implement a divide-and-conquer means of execution. Further, in this case, if full fidelity is maintained a portion of the query expression can fallback and execute locally. In yet another instance, queries can be cross-targeted across different programming languages and linked against potentially different libraries. For example, reactive extension queries (e.g., queries over asynchronous data streams) can be sent to a client to be executed in JavaScript against a reactive-extension, JavaScript library.

The serialized data 130 produced by the serialization component 110 can be of one of many available formats. JSON (JavaScript Object Notation) is often utilized herein in conjunction with examples of various disclosed aspects. However, the claimed subject matter is not limited thereto. In addition to those serialization formats that may be known to those of skill in the art, novel formats are also contemplated and within the scope of the subject disclosure.

By way of example, the serialization component 110 can generate an audio format such as MP3 utilizing text-to-speech functionality over program code. The deserialization component 120 can restore the program code utilizing speech-to-text functionality over an audio stream. In other words, a program can be serialized as a type of song. Furthermore, technology exists to recognize an entire song given the first few seconds of the song. Accordingly, such technology can be exploited to project, or infer, a program from a small portion thereof Program code can thus be compressed utilizing such functionality amongst other functionality employed to compress audio files.

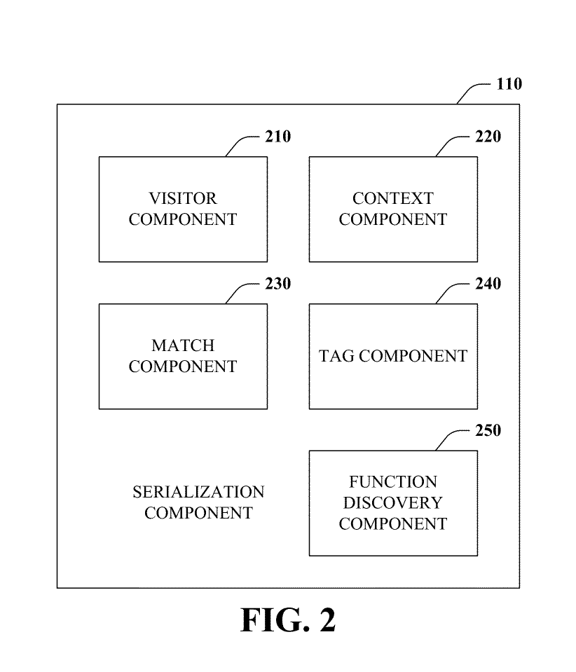

Turning attention to FIG. 2, a representative serialization component 110 is depicted in further detail. Here, the serialization component 110 comprises visitor component 210, context component 220, match component 230, tag component 240, and function discovery component 250. The visitor component 210 is configured to visit, or in other words traverse, an object graph, for example recursively. For each object visited, the function structure 140 of FIG. 1 can be consulted to enable further action to be taken. In one embodiment, rules of the function structure 140 can be based on type information and/or predicates applied to an object being considered. The action taken can include serialization or a recursive visit to child nodes that can be serialized in turn, which could induce creation of other rules based on dynamically discovered data.

The context component 220 is configured to acquire and maintain context information or, more simply, context. In one embodiment, the context component 220 is configured to gather data concerning serialization of data, or metadata. For example, the context component 220 can create a lookup table, dictionary, or like data structure, that maps object identities to corresponding data. Serialization of a graph can involve looking up objects in the table by identities and adding them to the table if not currently present. This can result in a definition, “def,” and reference, “ref,” construction where serialization of an object graph itself includes solely reference nodes. After serialization of the object graph, the context including the definitions can be serialized as well. By way of example:

```
class Bar
{
  public int Foo;
  public Bar Self;
}
var bar = new Bar { Foo = 42 };
bar.Self = bar;
```

Serializing the instance “bar” can result in an entry in a context table for the object “Bar” as follows in a pseudo-syntax of some serialization format:

1 → Bar with Foo := Value(42 : Integer), Self := Ref(1 : Bar)

In one instance, the context can be utilized to detect and address any cycles in an object graph. As can be observed from the above example, the object “Bar” includes a reference node, “Ref,” to an entry in the table, namely itself Absent built and maintained context, a recursive in-depth visit of the object graph would continue to traverse the “Self” reference endlessly. This can be prevented by detecting object identities and looking up whether a definition already exists for them in the table. If not, a definition is added. Otherwise, reference to an existing entry can be returned.

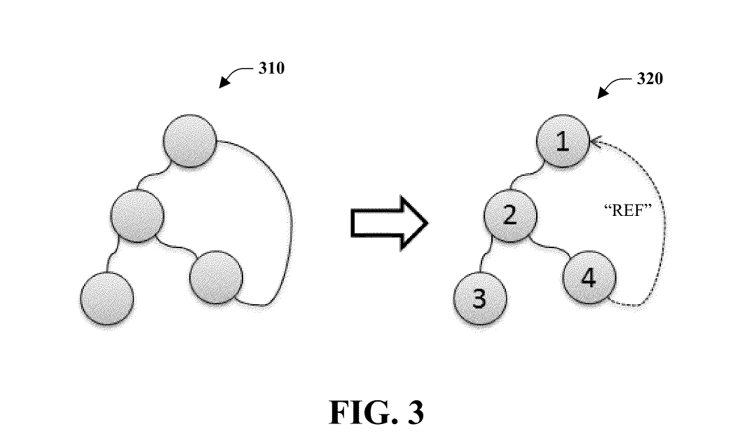

Turning briefly to FIG. 3, an example of cycle detection is illustrated. A first object graph 310 is shown with a number of nodes representing objects and lines between the nodes denoting object relationships. Second object graph 320 shows context information as it applies to the first object graph 310. Starting at the top, each node can be visited by way of visitor component 210. If an object identity and definition is not present in a context table upon visiting a node representing an object, they are added to the context table. Else, a reference to an entry can be returned. Here, the objects are visited in numerical order and provided the noted identity (e.g., 1, 2, 3, 4). When visiting the object with identity “4” it is noted that the relationship to the object with identity “1” is cyclic, and thus a reference can be inserted into the table. In other words, an equality check is performed based on object identity to determine that an object was already encountered.

Other notions of equality can be utilized instead or in addition to reference equality. Specialized equality testing can be supplied on a rule-level basis, allowing specialization beyond what is provided by objects themselves (e.g., virtual Equals method). For instance, an object “A” can be considered equal to an object “B” even though two different developers, unaware of each other, defined the objects or more specifically the corresponding types. This aligns with external serialization, that is, the ability to serialize an object graph whose contributing types are beyond the control of a serializing party.

By way of example, consider a milkshake and a hamburger. Each is a different food item, but they each equate to 1,000 calories. Therefore, if you have a hamburger object and a milkshake object and both are equal in terms of calories, instead of serializing the hamburger object and the milkshake object, both can be represented by 1,000 calories. Now there is a shared representation for both. In some sense, this is like applying lossy compression (e.g., a compression function) to serialization, where data is compressed by way of a compression function that discards, or loses, some data to minimize the amount of data that is transmitted. Here, both a hamburger object and a milkshake object can map to 1,000 calories in a context table and subsequently be serialized as a 1,000 calories. Subsequently, 1,000 calories can be de-serialized to either a hamburger object or a milkshake object.

The match component 230 is configured to match objects to serialization functions. Matching can be performed based on rules. For example, in a table-driven serialization and deserialization system, a mapping between matching rules and a pair of serialization and deserialization functions can be employed. Such a mapping can be simply referred to as a rule.

An example of a rule associated with serialization and deserialization to JSON (JavaScript Object Notation), a serialization format, is as follows:

```
{
    “Int32”, default(int),
    (i, _, _) => Json.Expression.Number(i.ToString( )),
    (jo, _, _) => int.Parse(((Json.ConstantExpression)jo).ToString( ))
}
```

In the first line, there is a type identifier “Int32” and a type. The type identifier is a tag that identifies an original type to preserve full fidelity serialization and deserialization. The type “int” identifies this as a rule for serialization and deserialization of integers. The second line is the serialization function, and the third line is the deserialization function. The serialization function takes “i,” an integer, as well as a recursive visitor function and a context object that tracks context during serialization both of which are not used here, as indicated by a dash in respective positions. The deserialization function takes a JSON object and could take a recursive visitor function and context object to facilitate deserialization both of which are not used in this example.

The above fragment can be part of a collection initializer expression used to instantiate a serializer object in one embodiment. In other words, the above fragment acts as an element of a serializer's set of rules. The parts denoting the elements “key” include a type identifier (which can be used for type tagging discussed later) and the type itself. The type can be inferred to be a phantom type, that is, by means of a default-expression rather than a type-of-expression. For example, an anonymous type (or the structured thereof) could be inferred from specification of “new {a=default(int), b=default(string) I.”). Notice this is not restricted to the use of “default(T),” but really boils down to specifying an example instance of the type to be serialized for type inference of the rule's serialization type. This can enable static typing of the serialization and deserialization functions that follow the default expression.

For actions associated with an entry's key, there are two lambda expressions, for instance. The first of those acts as the serialization function to be invoked when an “int32” value, here assigned the parameter “i” is encountered during a recursive visit. The first ignored, “_” parameter can include a recursive visit function. The second ignored, “_” parameter can include a context. The inverse function is similar.

Diving into the declaration of the exemplary rule, consider the following declaration of a “Serializer” type:

class Serializer<I, O, C> : List<Rule<C>> where C : new( )

This generic parameters used here indicate the input type (e.g., expression tree whose type is Expression), the output type (e.g., representation of a JSON expression), and a context type (e.g., maintain “def” and “ref” for cycle detection).

On this type, an “Add” method exists to enable the collection initializer syntax shown earlier. Different overloads facilitate various ways of supplying a rule, which ultimately results in construction of a “Rule<C>” object. The overload exercised by the “Int32” rule shown above can be as follows:

```
public void Add<T>(string name, T witness,
                Func<T, Func<object, C, object>, C, object> serialize,
                Func<object, Func<object, C, object>, C, T>
deserialize)
```

Here, “witness” plays the role of an instance of a phantom type as described above. The serialize and deserialize functions can be of higher order and include recursive callback parameters that allow for in-depth serialization. This has not been shown yet, since serialization and deserialization of an “Int32” does not require recursion. A sample rule with recursion is as follows:

```
{
    “Expressions”, default(ReadOnlyCollection<Expression>),
    (es, serialize, ctx) => Json.Expression.Array(
            from e in es
            select (Json.Expression)serialize(e, ctx)),
    (jo, deserialize, ctx) => (
            from e in ((Json.ArrayExpression)jo).Elements
            select (Expression)deserialize(e,
            ctx)).ToList( ).AsReadOnly( )
}
```

Here, upon visiting a collection of Expression objects, serialization is pushed down onto individual elements to be collected in the serialization representation of an array (here a JSON array). In the opposite direction, the array representation is decomposed and the deserialization function is invoked recursively.

Rules can be more elaborate with regard to matching logic, also allowing for specification of a predicate, for example, to provide filtering functionality. This can be useful when matching happens not only based on some runtime type but also the value of the object:

```
public void Add<T>(string name, T witness, Func<T, bool> filter,
                Func<T, Func<object, C, object>, C, object>
serialize,
                Func<object, Func<object, C, object>, C, T>
deserialize)
```

Notices the order of rules added to the generic serializer matter, as type checks will be carried out in the order of the rules appearing in the underlying list. Once a match is found (e.g., based on a type “is” check and evaluation of a filter, if any) that is the rule that is selected. In other words, rather than tying serialization solely to looking at type, a specific rule can be invoked based on some predicate. The ability to specify a filter allows the system to narrow down the search for a serialization rule, among other things.

Returning to context briefly, a context type “C” can be used for a variety of purposes in addition to tracking object definitions and references as described above. For example, the context can be used to maintain scope for lambda expression (e.g., function without a name that computes and returns a single value) parameters. Use of code expression and corresponding expression tree serialization, is a good sample use of maintenance of scope for lambda expression parameters. A lambda expression can be declared with multiple parameters with the same textual name. Parameters can be treated using reference equality, so two such parameters can have the same name but be treated as different. For example:

var a = Expression.Parameter(“a”, typeof(int));
var b = Expression.Parameter(“a”, typeof(int));
// Notice the name is also “a”
var c = Expression.Lambda(Expression.Add(a, b), a, b);
// Looks like (a, a) => a + a when printed!

To serialize expression “c,” expression for parameters “a” and “b” can be visited recursively. Serializing a parameter expression solely be means of its name and type will not suffice since reference equality matters to a target application-programming interface (API). Similar issues scan arise when nested functions are being declared where name conflicts can occur and scoping matters. To account for this, a context type can be defined that is threaded through serialization and deserialization processes to ensure unique identifiers for parameters are mapped to their friendly textual names.

An example of a complex serialization function is shown below used in the context of serializing a lambda expression:

```
“Lambda”, default(LambdaExpression),
(le, serialize, ctx) =>
{
  ctx.PushFrame( );
  var parameters =
    Json.Expression.Array(
      from p in le.Parameters
      select Json.Expression.Object(
        new Dictionary<string, Json.Expression>
        {
          { “Name”, Json.Expression.String(ctx.ExtendFrame(p))
},
          { “FriendlyName”, Json.Expression.String(p.Name) },
          { “Type”, (Json.Expression)serialize(p.Type, ctx) }
        })
    );
  var body = (Json.Expression)serialize(le.Body, ctx);
  ctx.PopFrame( );
  return Json.Expression.Object(
    new Dictionary<string, Json.Expression>
      {
      { “Parameters”, parameters },
    { “Body”, body },
    }
  );
}
```

When a lambda expression is encountered a push frame is invoked which will establish an environment so that when serialization recurses into the body, parameters can be can be looked up in context. It is simply a way of establishing scoping. First, parameters are serialized and then added to context to know where scope starts and ends. Next, serialization can be invoked on the body. Subsequently, an object that includes both parameters and the body is returned. When a parameter is encountered in an expression, the context can be consulted to determine the declaration scope of the parameter (e.g., for “a=>a=>a,” does the “a” in the body refer to the parent or the grandparent scope?). The push frame and pop frame reflect block structure of the binding of the parameter names and the lambda expression.

Deserialization code is similar, exploiting the context to track nesting scopes for parameters, mappings, and whatnot. In other words, serialization can be performed with or without a context object that tracks additional state. This allows for gradations of declarative serialization and deserialization, where one has more control, if needed.

Contexts are not just used within the serialization and deserialization phases of the object graph. They can also be consulted to finish off the entire serialization or deserialization phases. For example, in the context of serialization of “Type” objects (e.g., the representation of a type from a reflection's point of view), the following context interaction is used:

```
{
  “Type”, default(Type),
  (tp, _, ctx) => ctx.RegisterType(tp).ToJson( ),
  (jo, _, ctx) =>
ctx[int.Parse((string)((Json.ConstantExpression)jo).Value)]
}
```

Here, the “RegisterType” call returns a “TypeRef” object, while putting the type object “tp” in a dictionary maintained inside the context. For example, typeof(int) itself could be serialized into “1”, a reference to an entry in the context being reused for every occurrence of a “typeof(int)” object in some serialized object graph. In order to reconstruct, during deserialization, the “Type” object, serialized form of the mapping between types can be appended to their references ordinal numbers.

To hydrate and rehydrate context into and from a serialized form, the functions can be accepted that deal with the serialization and deserialization of the context object, for example as follows:

```
(json, ctx) => Json.Expression.Object(new Dictionary<string,
Json.Expression>
{
    { “Types”, ctx.ToJson( ) },
    { “Value”, json }
}),
json =>
JsonSerializationContext.FromJson(((Json.ObjectExpression)json).
Members[“Types”])
```

The tag component 240 is configured to add metadata to enable selection of an appropriate rule, or more specifically, a deserialization function. Deserialization code can utilize a deserialization function to reconstruct an object graph. A tag, or identifier, can be added to a serialized data stream to aid selection of the deserialization function. By way of example, a string literal can precede witness of phantom type specification:

“Expressions”, default(ReadOnlyCollection<Expression>)

In here, “Expressions” is the name of the serialization rule, which can be enforced to be unique in the rule set being specified. This identifier can be included in the serialized form of the graph to enable the node to be deserializable using a corresponding rule. In order to include (during serialization) and extract (during deserialization) this information, a pair of functions called “tag” and “untag” can be used.

After a recursive serialization call for a given object, the selected rule can be applied. As a result, serialization output object can be produced. Before embedding it in the larger serialization data (e.g., by means of returning from the recursive call and scan the rest of the graph according to the recursion strategy being used), the tag function can be called to bundle the serialized data together with the tag's identifier. Upon deserialization, the untag function can be called to extract the “body” of the object to be deserialized, as well as the rule to be used to deserialize the object. As an example, below is a tag function:

```
(json, tag) =>
    inlined.Contains(tag)
    ? json
    : Json.Expression.Object(
        new Dictionary<string, Json.Expression>
        {
            { “Type”, Json.Expression.String(tag) },
            { “Value”, (Json.Expression)json }
        }
    ),
```

Sometimes tags can be omitted (e.g., because the underlying serialization format has some notion of types, such as JSON supporting a “Boolean literal”). If not, the tag function can wrap the given serialized data in a larger piece of data also containing the tag provided by the serialization engine. The corresponding “untag” function does the opposite. That is, the function extracts the “Type” (which reveals the rule to be used for the deserialization) and the “Value” to be fed to the recursive deserializer.

The function discovery component 250 is configured to identify, discover, or otherwise determine or infer functions and/or inverse functions, such as serialization and deserialization functions. In one instance, a developer can hand code such functions in an imperative manner. Alternatively, the function discovery component 250 can enable specification of functions in a declarative manner. Here, a developer can specify a so-called roundtrip function that is analyzed and used to build recursive functions on the fly on the developer's behalf Consider for example a simple roundtrip function corresponding to serialization of an integer to a string and deserialization of a string back to an integer:

x => int.Parse(x.ToString( ))

From this roundtrip function it can be determined or inferred that “x=>x.ToString( ) is the serialization function and “s =>int.Parse(s)” (e.g., a static method on a result type using input string as serialization format to perform deserialization operation) is the deserialization function.

Another example of a round trip function is shown below:

(MethodCallExpression mc) =>
Expression.Call(mc.Object, mc.Method, mc.Arguments)

The roundtrip function indicates that in order to serialize a “MethodCallExpression,” the objects “Object, “Method,” and “Argument” properties should be recursively serialized. To enable this data to be deserialized, the node can be tagged (as previously described), here simply using the type name of the object. However, this could be overridden by specifying a name for a rule in one of the overloads.

The deserialization function can be inferred from the roundtrip function. After recognizing all the lookups performed on the parameter “mc,” these can be identified as holes. This means the data for those can be found by means of recursive deserialization of the serialized data. Once, the “Object,” “Method,” and “Arguments” data has been deserialized, those values can be used as the arguments to call “Expression.Call” in order to reconstruct the original “MethodCallExpression.

All of the above is equivalent to writing the following by hand:

```
mc, serialize, _) => new Dictionary<string, object>
{
    {“Object”, serialize(mc.Object)},
    {“Method”, serialize(mc.Method)},
    {“Arguments”, serialize(mc.Arguments)},
},
(o, deserialize, _) => Expression.Call(
    (Expression)deserialize(((Dictionary<string, object>)o)[“Object”]),
    (MethodInfo)deserialize(((Dictionary<string, object>)o)[“Method”]),
    (Arguments)deserialize(((Dictionary<string,
    object>)o)[“Arguments”]),
)
```

The above code can be automatically generated based on the roundtrip function. This assumes some name-value mapping collection type can be serialized and deserialized, for example by using a dictionary structure, “Dictionary<string, object>.” The function discovery component 250 can be configured to perform pattern recognition over expressions in order to identify “recursion islands.” In the above, this is based on plain uses of the “mc” parameter, but more sophisticated recognition schemes are contemplated.

By way of example, a product may be defined as follows:

new Product { Name = “Chai”, Price = 125.99m, Category = beverages }

Assume each “Category” has a unique identifier property inside the category. Also, assume a roundtrip function for “Product:”

p => new Product { Name = p.Name, Price = p.Price,
Category = p.Category }

A naïve approach would serialize the whole category object despite its unique key property. This would happen for every use of the same category. Solving this issue can be achieved in multiple ways, for example by using a definition/reference recognition (e.g., mapping used category onto an ordinal number and referring to it by number) or by hinting, or notifying, a serialization component what is sufficient to serialized in order to reconstruct the data:

p => new Product { Name = p.Name, Price = p.Price, Category =
Serialize.With(p.Category, c => c.Id, ...) }

The “Serialize.With” call can act as a pattern to be matched during roundtrip function analysis by the function discovery component 250. Additional arguments can be used to specialize the node's serialization/deserialization behavior. Here, for example, it is indicated that the object “Category” should be serialized in a particular way, namely utilizing “Id.” The ellipsis in the sample above specify additional/different behavior for deserialization, for example by looking up the key from a common available resource.

The use of roundtrip functions allows for a gradual approach to serialization/deserialization, where all but the more involved, or complex, object graph nodes, for example, can be serialized/deserialized using generated rules. Further, more patterns can be acquired to be more efficient regarding extraction and reconstruction of object.

The function discovery component 250 can further be configured to exploit reflection to discover appropriate serialization and/or deserialization function. Thus far, a closed set of rules supplied by a serialization component rule set has been assumed. When no suitable rule is found for an object to be serialized, an exception can result. However, assuming the ability to serialize and deserialize a name-value mapping collections, a fallback mechanism can be provided. In such a case, a request to serialize and object of an unknown type can result in extension of the rule set with a pair of generated serialization and deserialization functions, which are based on reflection information obtained from an input object.

One implementation of such functionality can be simply to reflect on an object's fields or mutable properties and generate recursive code that stuffs each of the serialized decomposed parts of the object into a dictionary mapping them to field or property names. For the previously described tagger to work correctly here, it suffices to extend context with a mapping from unique tags (e.g., one per type) on to the corresponding type information. Below is discussion of how static type information can be used to serialize and deserialize. The process of creating serialization and deserialization functions for a discovered type can be sped up by using context to store type-related information.

Generally, serialization and deserialization are inverse functions. Composing both together results in the identity function, which leaves a given input object unaffected. Notice this process in general can guarantee structural equality of the input and round-tripped result, in that object equality is generally not preserved for an entire object graph (though occurrences of aliased objects within the graph should result in similar aliasing).

There are cases, however, where serialization and deserialization can be at least slightly asymmetric. For example, one may simply want to serialize strongly typed C#® objects into JSON expression, ignoring precise typing of numbers, for example. Similarly, the deserialized form of a JSON object could be entirely dynamically typed (e.g., using expando objects that can be accessed naturally through C# dynamic). In such a setting, there is an imbalance between the “weight” of serialization and deserialization functions kept in a rule set. As an example, for the latter case of deserializing a JSON object, simply returning a dynamically typed object is simple, while precise type reconstruction would involve more work.

Some generic services such as tagging and untagging can also be implemented more trivially if the degree of roundtrip confidence has less stringent needs. For example, when deserialization of JSON can afford to return an expando object (an object whose members can by dynamically added and removed at run time), there is no need for the tagger to store precise rule identification information. In this case, the deserialization component is not going to use such information anyway, as it will create expando objects.

When high fidelity round tripping of strongly typed objects (e.g., common language runtime (CLR)) is desirable, reflective information such as “System.Type” object can be serializable as well. This allows for precise reconstruction of objects from a typing point of view. An example where this becomes relevant is in the serialization and deserialization of code expressions, or in other words expression trees:

LambdaExpression Capture<R>(Expression<Func<R>> e)
{
return e;
}
var f = Capture(( ) => new { Name = “Bart”, Age = 27 });

In the above code fragment, “f′ is a lambda expression's data representation in the form of an expression tree. This object includes rich information about the structure of the expression tree, such as that the function body is a constant expression. However, the type of this constant expression is an anonymous type, which was generated by a compiler. In order to serialize the expression tree, enough information should be captured about this type in order to be able to reconstruct the type. This is one sample of where type reconstruction is rather involved. The ability to capture any type, or other piece of reflective information, is significant in providing full fidelity roundtripping of object graphs. In order to achieve this, a definition and reference scheme for type information can be used allowing for cycles that occur in constructed recursive types.

To capture type information, a number of categories for types can be distinguished. One is primitive types that are known by both sides of a serialization/deserialization cycle. This can include things such as “System.Int32” or “System. String,” for example. For other types, precise specification may be needed, including full type identity comprising a declaring assembly with or without a strong name. The deserialization component 120 can have a side effect of loading non-standard types based on information supplied. Besides those kinds of types, there are also constructed types, which include arrays, nullables, and generics. Consider for example:

Dictionary<int, string[ ]>

This type, “Dictionary,” has no less than five constituents that contribute to a definition table:
First, there are the “int” and “string” types, which likely lack further specification as they are special-cased as well-known primitives. In fact, this even applies across different platforms and languages in quite some cases, since things like 32-bit signed integers and Unicode strings are consistently defined.
Next, there are the constructed types for the array definition (including a number of dimensions to allow multi-dimensional arrays) that reference an entry for string (in other words, string-array).
For the generic Dictionary type usage, two types are involved. One is the generic definition (“open”) itself, which includes data about the place to find the type in (e.g., the assembly and namespace). The other is the constructed type (“closed”), which on its turn refers to the entry for the “int” type and the entry for the (constructed) string-array type.
   An example type-definition table for the type shown here looks as follows, using JSON syntax:

```
″Types″: [
  {
    ″Typ″: ″System.Collections.Generic.Dictionary\grave{ }2″
  },
  {
    ″Type″: ″System.Int32″
  },
  {
    ″Type″: ″System.String″
  },
  { “ElementType”: 2, “Dimensions”: 1
  },
  {
    ″GenericType″: 0,
    ″Arguments″: [
      1,
      3
    ]
  }
],
```

For anonymous types, which are (somewhat imprecisely) referred to as “structural types,” the type definition entry includes references to the constituent types paired with the name of the corresponding properties. On the deserializing end of the picture, encountering such a structural type may require runtime generation of a type definition, for example using .NET's System.Reflection.Emit API or compiler-as-a-service facilities. Before resorting to this, an exact match for the type could be carried out (e.g., it may be the case that a type with the same “shape” already got loaded in the current application domain).

In accordance with one embodiment, serialization can be applied with respect to code expressions, or in other words expression trees. The disclosed serialization functionality can be used for cross-targeting expression trees, for instance between C# and JavaScript. In a broader context, serialization of expression trees allows for transport of query expression to facilitate scenarios such as verbatim query-expression remoting (e.g., making an object available across remoting boundaries including application domains, processes, or different network-connected computers) and tier splitting (e.g., distributed execution across multiple tiers such as client, server, middleware).

Possible uses of this include, but are not limited to:
Remoting, or in other words transmitting, query expressions into a database server process and exploit runtime services inside the database to execute the query (rather than going through an intermediate syntax such as T-SQL, requiring redundant compilation and checking on different levels).
Distribution of query fragments, for example to broker services. Such a service could reconstruct part of the original query for local execution while continuing to distribute other parts (recursively, if you will) to other brokers. Since the expression tree is preserved will full fidelity (type) information, any service can fall back to verbatim execution thereof if no more intelligence can be applied to execute the query by means of divide-and-conquer.
Cross-targeting of queries across different languages, “linking” against potentially different libraries. For example, reactive extensions (Rx) queries can be remoted to a client and be executed in JavaScript (JS) against an RxJS library.

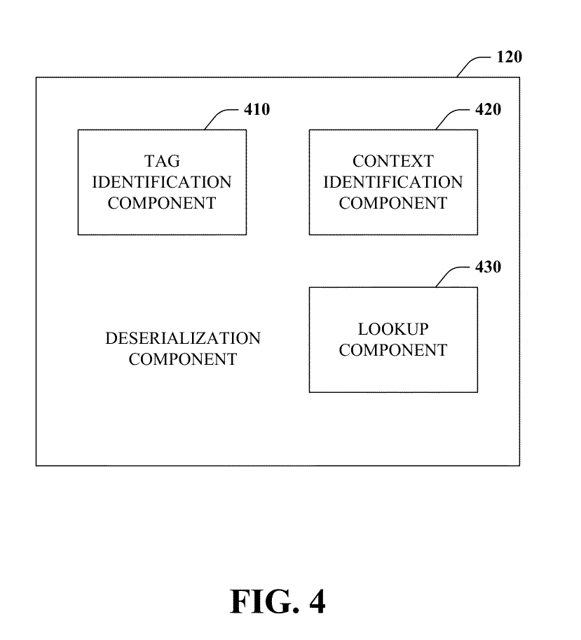

FIG. 4 depicts a representative deserialization component 120 in further detail. The deserialization component 120 includes tag identification component 410, context identification component 420, and lookup component 430. The tag identification component 410 is configured to identify a tag or identifier associated with serialized data. In one embodiment, a tag can correspond to a type identifier. Of course, other information, or metadata, can also be captured by a tag. In one instance, an “untag” function can be called to extract the “body” of the object to be deserialized as well as reveal the tag or identifier.

The context identification component 420 is configured to identify context. For example, context can be associated with mappings between object identities and data as well as tracking of nesting scopes for parameters, among other things. Generally, the context identification component 420 can identify, discover or otherwise obtain contextual information to the extent such metadata is serialized or otherwise available for acquisition.

The lookup component 430 is configured to lookup, identify or otherwise determine or infer deserialization functions for a set of objects. In one instance, the lookup component 430 can utilize a tag or other identifier (e.g., type identifier) associated with an object to lookup a deserialization for example in a table (e.g., table-driven deserialization).

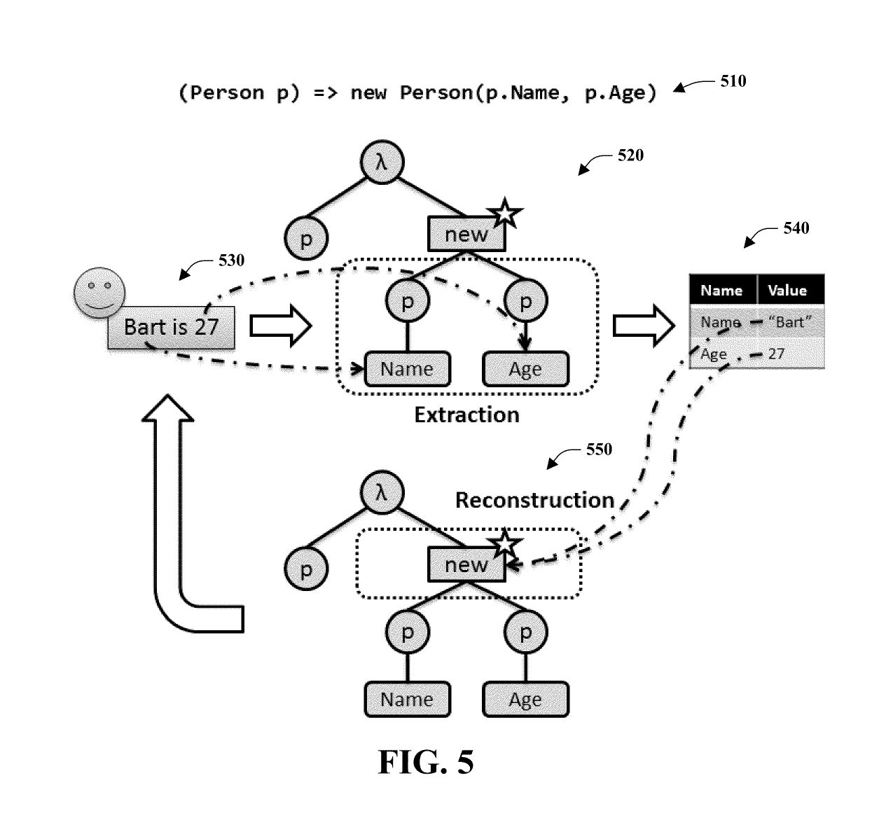

Turning attention to FIG. 5, an exemplary serialization and deserialization scenario is illustrated. This example concerns lambda expression 510, namely: “(Person p)=>new Person(p.name, p.Age).” The lambda expression 510 is represented as object graph, or expression tree, 520. As shown, the top node is “λ” corresponds to the entire lambda expression 510 with children “p” (of type “Person”) and “new” denoting a new “Person.” Here, “new” also has children representing “p.Name” and “p.Age,” which correspond to data 530, namely “Bart is 27.” During serialization, context can be extracted to map type names to values as provided in table 540. Upon deserialization, a deserialization object graph 550 is produced. Here, the “new” node can be reconstructed based on the context supplied by table 540. As a result, “p.Name” and “p.Age” again correspond to data 530—“Bart is 27.” A roundtrip has been illustrated from the object graph 520 which is serialized and then deserialized, for example in a different address space, to produce the deserialization object graph 550, which is the same as object graph 520. In this example, enough information was captured in table 540 to allow what could be an anonymous type to be reconstructed.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, such mechanisms can be employed to automatically or semi-automatically infer serialization and/or deserialization functions.

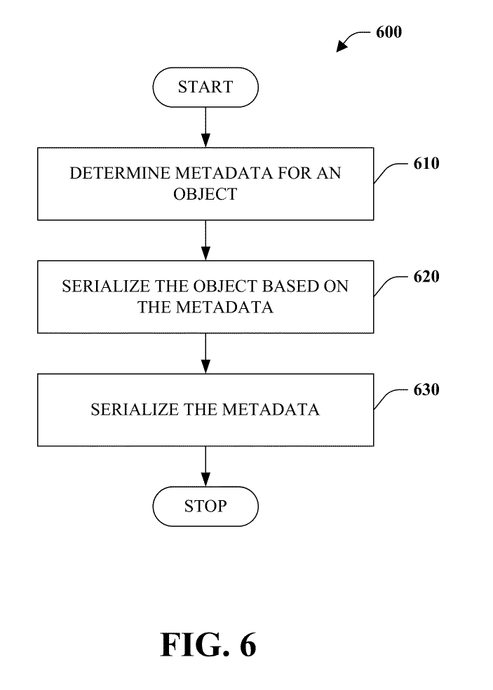

In view of the exemplary systems described supra, methodologies that may be implemented in accordance with the disclosed subject matter will be better appreciated with reference to the flow charts of FIGS. 6-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 6, a serialization method 600 is illustrated. At reference numeral 610, metadata for an object is determined The metadata corresponds to data regarding an object can include substantially any data such as but not limited to types, properties, relationship to other objects, environment (e.g., source, destination), or scope. Such a determination of metadata can be accomplished utilizing a variety of means including analysis, inference, or reflection, among others. Furthermore, such metadata is collected external to a particular object model. In other words, metadata is collected outside conventional attributes or interface implementations associated with an object when an object type is designed without serialization in mind At numeral 620, the object is serialized based on the metadata. For example, based on the metadata, a serialization function is generated or a known serialization function is selected and subsequently applied to the object. In accordance with one aspect of the disclosure, the serialization function can be configurable to enable serialization at different levels of detail, for example from serialization that preserves substantially all data to serialization that intentionally loses, or drops, at least a portion of data such as that which is not employed by a target deserialization entity. At reference numeral 630, the metadata is serialized. In this manner, an entity seeking to deserialize an object can receive metadata that can be employed to generate or select a known deserialization function.

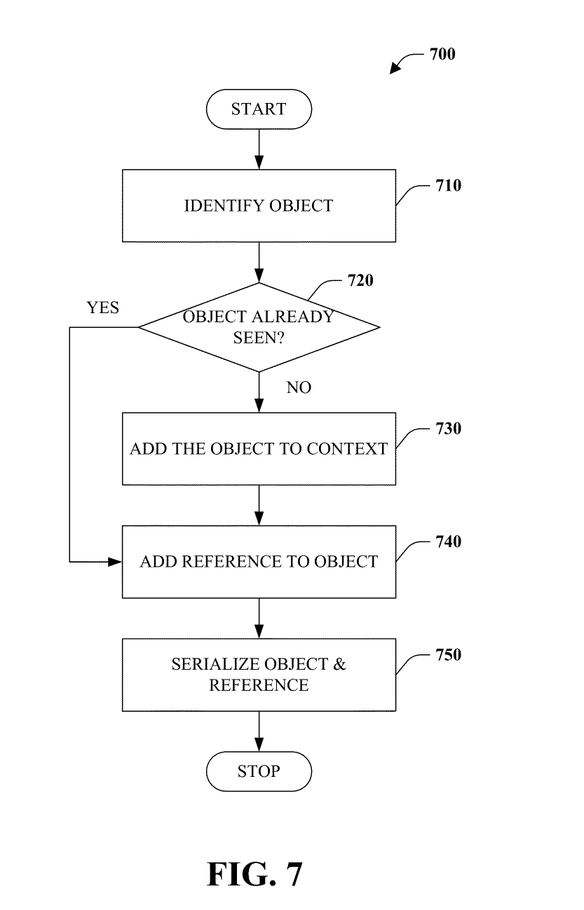

FIG. 7 depicts a method of serialization 700 that accounts for cycles. At reference numeral 710, an object is identified perhaps in accordance with visiting, or in other words traversing, a graph of related objects. A determination is made at 720 as to whether the identified object, or object graph node, has already been seen or encountered. For example, a table or like structure employed to track context can be used to look up the identified object. If the object is present, it was previously encountered. Otherwise, the object was not previously encountered. In this manner, object graph cycles can be detected. If, at 720, it is determined that the object was not previously seen (“NO”), the object, or more specifically an object definition, can be added to context vis-à-vis a table or like structure at 730. In one embodiment, an object definition can correspond to a dictionary of object identities mapped to corresponding data. Alternatively, if it is determined that the object was seen previously (“YES”), the method 700 adds a reference to the object from a previously identified object at 740. At reference numeral 750, the object, or definition thereof, and references can be serialized. For instance, a graph of objects can be serialized including solely reference nodes while context can be serialized with definitions corresponding to reference nodes.

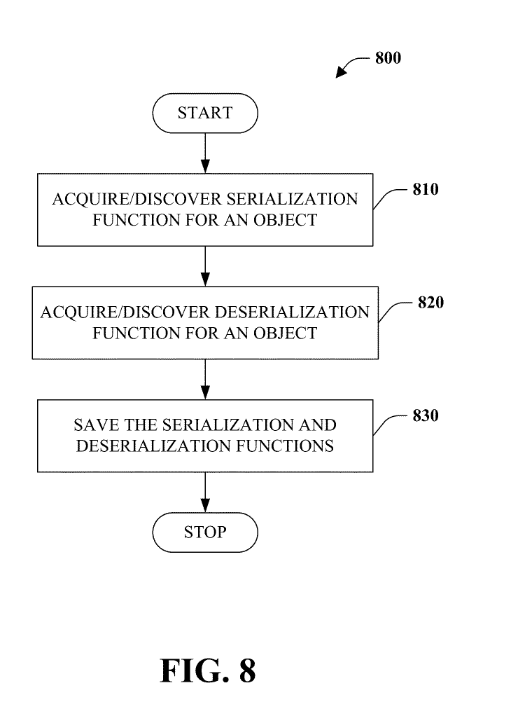

FIG. 8 is a flow chart diagram illustrating a method 800 of facilitating serialization and deserialization. At reference numeral 810, a serialization function for an object is acquired or discovered. In one instance, a serialization function can be written by and acquired from a developer. In another instance, a developer can specify a roundtrip function declaratively from which the serialization can be discovered upon analysis of the roundtrip function. In yet another instance, the serialization function can be discovered or inferred from metadata regarding an object. For example, based on metadata a manner of recursively traversing an object structure can be determined as well as how objects or sub-objects are to be encoded. At reference numeral 820, a deserialization function is acquired/discovered for an object. In one scenario, the deserialization function can be discovered from a known serialization function. Similar to acquisition/discovery of a serialization function, other scenarios can involve acquiring the function directly from a developer or discovering the deserialization function from a roundtrip function, among others. At reference numeral 830, the serialization and deserialization functions are saved to a computer-readable storage medium for subsequent reference.

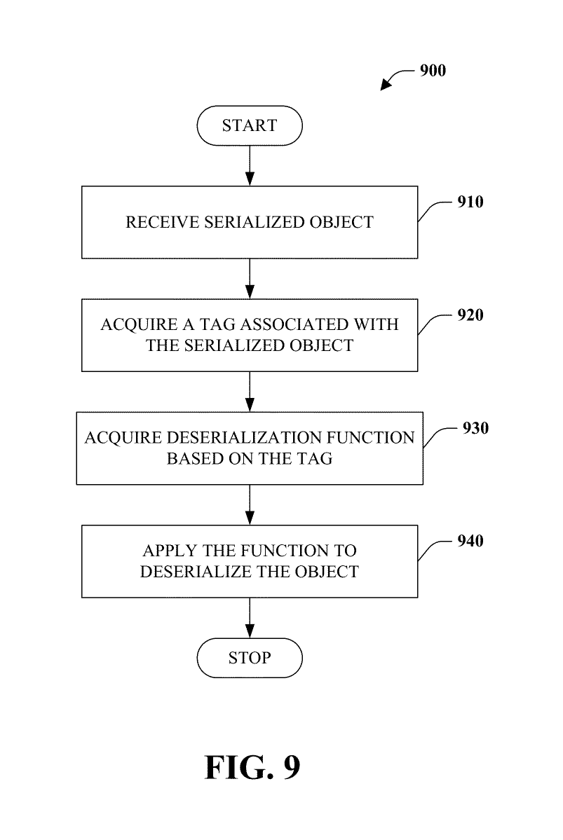

FIG. 9 illustrates a method of deserialization 900. At reference numeral 910, a serialized object is received, retrieved, or otherwise obtained or acquired. At numeral 920, a tag, or in other words an identifier, is acquired from the serialized object. For example, such an identifier can be acquired by executing an “untag” function over the serialized object. At numeral 930, a deserialization function is acquired based on the tag. For example, the tag can be used as a key to lookup a corresponding deserialization function in a table or other data storage structure. At reference numeral 940, the acquired deserialization function is applied to deserialize the serialized object.

An open world is assumed through much of this disclosure meaning an object, or more specifically a type, is not under control of a serializing party. To address this situation a table, for example, is employed that acts as an external oracle regarding serialization and deserialization functions. However, if a serialized target object model is under control of a serializing party deserialization functions could be injected therein. However, the serialized object model is often a general-purpose representation such as XML or JSON and it is not very efficient to have a domain-specific conversion function (e.g., ToExpressionTree) for every object (e.g., XElement). Hence, deserialization functionality can typically be exposed through a method on a result type. For example, “int.Parse(s)” uses an input string as the serialization format on which to perform a deserialization operation to produce a resulting integer.

As used herein, the terms “component” and “system” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

The conjunction “or” as used this description and appended claims in is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘A’ and ‘B,’” then “‘A’ employs ‘X’ or ‘Y’” is satisfied under any of the foregoing instances.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

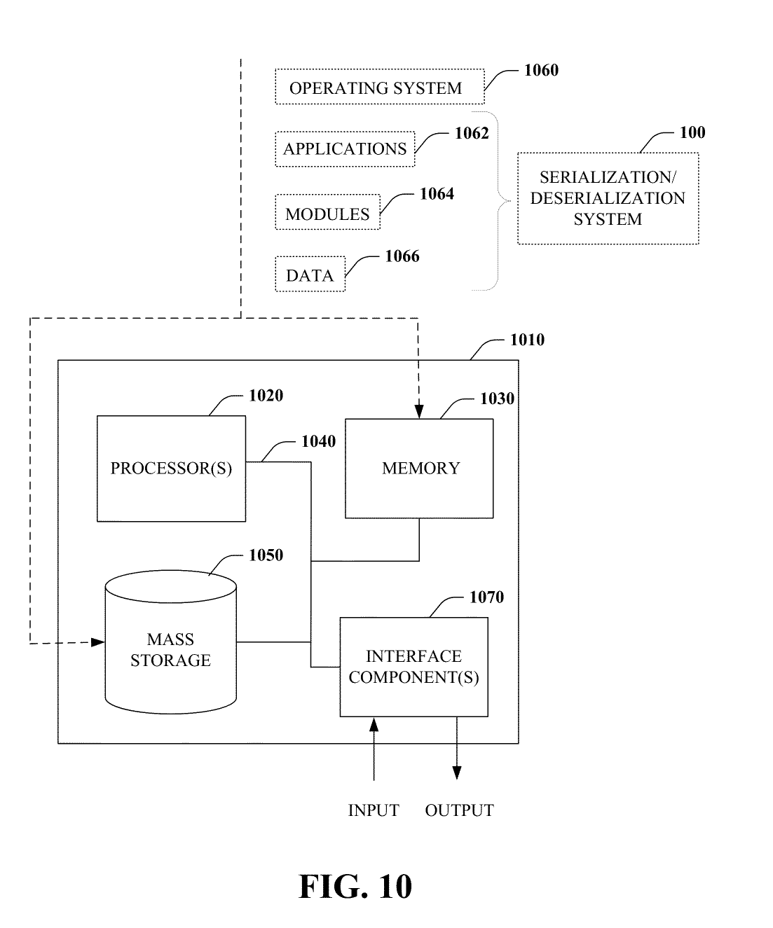

In order to provide a context for the claimed subject matter, FIG. 10 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 10, illustrated is an example general-purpose computer 1010 or computing device (e.g., desktop, laptop, server, hand-held, programmable consumer or industrial electronics, set-top box, game system . . . ). The computer 1010 includes one or more processor(s) 1020, memory 1030, system bus 1040, mass storage 1050, and one or more interface components 1070. The system bus 1040 communicatively couples at least the above system components. However, it is to be appreciated that in its simplest form the computer 1010 can include one or more processors 1020 coupled to memory 1030 that execute various computer executable actions, instructions, and or components stored in memory 1030.

The processor(s) 1020 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1020 may also be implemented as a combination of computing devices, for example a combination of a DSP and a microprocessor, a plurality of microprocessors, multi-core processors, one or more microprocessors in conjunction with a DSP core, or any other such configuration.

The computer 1010 can include or otherwise interact with a variety of computer-readable media to facilitate control of the computer 1010 to implement one or more aspects of the claimed subject matter. The computer-readable media can be any available media that can be accessed by the computer 1010 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1010.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1030 and mass storage 1050 are examples of computer-readable storage media. Depending on the exact configuration and type of computing device, memory 1030 may be volatile (e.g., RAM), non-volatile (e.g., ROM, flash memory . . . ) or some combination of the two. By way of example, the basic input/output system (BIOS), including basic routines to transfer information between elements within the computer 1010, such as during start-up, can be stored in nonvolatile memory, while volatile memory can act as external cache memory to facilitate processing by the processor(s) 1020, among other things.

Mass storage 1050 includes removable/non-removable, volatile/non-volatile computer storage media for storage of large amounts of data relative to the memory 1030. For example, mass storage 1050 includes, but is not limited to, one or more devices such as a magnetic or optical disk drive, floppy disk drive, flash memory, solid-state drive, or memory stick.

Memory 1030 and mass storage 1050 can include, or have stored therein, operating system 1060, one or more applications 1062, one or more program modules 1064, and data 1066. The operating system 1060 acts to control and allocate resources of the computer 1010. Applications 1062 include one or both of system and application software and can exploit management of resources by the operating system 1060 through program modules 1064 and data 1066 stored in memory 1030 and/or mass storage 1050 to perform one or more actions. Accordingly, applications 1062 can turn a general-purpose computer 1010 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the serialization/deserialization 100, or portions thereof, can be, or form part, of an application 1062, and include one or more modules 1064 and data 1066 stored in memory and/or mass storage 1050 whose functionality can be realized when executed by one or more processor(s) 1020.

In accordance with one particular embodiment, the processor(s) 1020 can correspond to a system on a chip (SOC) or like architecture including, or in other words integrating, both hardware and software on a single integrated circuit substrate. Here, the processor(s) 1020 can include one or more processors as well as memory at least similar to processor(s) 1020 and memory 1030, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the serialization/deserialization system 100 and/or associated functionality can be embedded within hardware in a SOC architecture.

The computer 1010 also includes one or more interface components 1070 that are communicatively coupled to the system bus 1040 and facilitate interaction with the computer 1010. By way of example, the interface component 1070 can be a port (e.g., serial, parallel, PCMCIA, USB, FireWire . . . ) or an interface card (e.g., sound, video . . . ) or the like. In one example implementation, the interface component 1070 can be embodied as a user input/output interface to enable a user to enter commands and information into the computer 1010 through one or more input devices (e.g., pointing device such as a mouse, trackball, stylus, touch pad, keyboard, microphone, joystick, game pad, satellite dish, scanner, camera, other computer . . . ). In another example implementation, the interface component 1070 can be embodied as an output peripheral interface to supply output to displays (e.g., CRT, LCD, plasma . . . ), speakers, printers, and/or other computers, among other things. Still further yet, the interface component 1070 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of external transformation, comprising:
employing at least one processor configured to execute computer-executable instructions stored in memory to perform the following acts:
transforming an object graph from a first form to a second form based on metadata discovered about one or more objects comprising the object graph external to a corresponding object model.

2. The method of claim 1 further comprises transforming one of the one or more objects with a function associated with an object type.

3. The method of claim 2 further comprises determining the function from a roundtrip function.

4. The method of claim 2 further comprises determining the function based on reflection information.

5. The method of claim 2 further comprises selecting the function based on a compression function.

6. The method of claim 2 further comprises transforming at least a subset of the metadata to the second form.

7. The method of claim 1 further comprises tagging the one or more objects with object type.

8. The method of claim 1 further comprises saving a type definition for one of the one or more objects or referencing a previously saved definition.

9. The method of claim 1 further comprises transforming the second form of the object graph to the first form.

10. The method of claim 1, transforming the object graph comprises transforming an object-graph representation of a query expression.

11. A serialization system, comprising:
a processor coupled to a memory, the processor configured to execute the following computer-executable components stored in the memory:
a first component configured to serialize an object graph based on metadata discovered about one or more objects of the graph external to a corresponding object model.

12. The system of claim 11 further comprising a second component configured to tag at least one of the one or more objects with object type.

13. The system of claim 11 the first component is further configured to invoke a serialization function based on object type.

14. The system of claim 11 further comprising a second component configured to serialize at least a portion of the metadata.

15. The system of claim 11, the object graph is a representation of a query expression.

16. A method of deserialization, comprising:
employing at least one processor configured to execute computer-executable instructions stored in memory to perform the following acts:
determining a deserialization function based on a tag linked to a serialized object that identifies object type; and
invoking the deserialization function on the object.

17. The method of claim 16 further comprises determining the deserialization function based on a rule.

18. The method of claim 16 further comprises determining the deserialization function from a roundtrip function.

19. The method of claim 16, determining the deserialization function comprises looking up the deserialization function in a table external to an entity deserializing the serialized object.

20. The method of claim 16, further comprising deserializing the object based on context information related to the object.
